(19) United States
(12) Patent Application Publication
(10) Pub. No.: US 2026/0060892 A1
(43) Pub. Date: Mar. 5, 2026

(54) Provider-Controlled Medication Dispenser and Methods of Use Thereof

(71) Applicant: Chalie Kaye Mackey, Mt Olive, MS (US)

(72) Inventor: Chalie Kaye Mackey, Mt Olive, MS (US)

(21) Appl. No.: 18/819,464

(22) Filed: Aug. 29, 2024

(51) Int. Cl. A61J 1/03; A61J 1/14

(52) U.S. Cl. CPC A61J 1/03; A61J 1/14; A61J 2200/70; A61J 2205/70

(57) ABSTRACT

The present invention relates to a medication dispenser apparatus and methods of use thereof. In one embodiment, the medication dispenser apparatus may comprise a medication, a housing for housing the medication, a dispensing mechanism, wherein the dispensing mechanism provides a means by which to dispense the housed medication in designated quantities, a locking mechanism, wherein the locking mechanism provides a means by which to restrict access to and/or the dispensing of the housed medication at designated times, a release button, and a visual indicator.

### CROSS-REFERENCE TO RELATED APPLICATIONS

Not applicable.

### BACKGROUND OF THE INVENTION

### Field of the Invention

The present invention relates to medication dispensers. More particularly, the present invention relates to medication dispensers that may adhere to a healthcare provider's administration instructions and ensure patient medication compliance.

### Background of the Invention

Medication compliance among patients may be considered a major problem in the healthcare industry. Patients may be prescribed various medications by healthcare providers and supplied these medications via disposable plastic containers with childproof lids and labels detailing administration instructions. By this current system and method, the responsibility of medication compliance falls solely to the patient, with the childproof lid being the extent of any sort of regulation. This may allow for medication misuse such as taking medication at the improper times, in the improper quantities, and/or by the improper people.

Currently in the healthcare industry, various medication dispensers or devices may exist to aid patients in medication compliance. Such dispensers or devices may be programable, lockable, capable of remote monitoring, and/or capable of transmitting alerts or reminders. However, such medication dispensers or devices only perform these functions at the will of a patient or caregiver. In other words, even with current “smart” medication dispensers or devices available, it remains the patient or caregiver's responsibility to properly set up and/or implement the various functionalities provided to better facilitate medication compliance.

Consequently, there is a need for medication dispensers that may adhere to healthcare provider's administration instruction and ensure patient medication compliance.

### BRIEF SUMMARY OF SOME OF THE PREFERRED EMBODIMENTS

These and other needs in the art are addressed in one embodiment by a medication dispenser apparatus comprising a medication, a housing for housing the medication, a dispensing mechanism, wherein the dispensing mechanism provides a means by which to dispense the housed medication in designated quantities, a locking mechanism, wherein the locking mechanism provides a means by which to restrict access to and/or the dispensing of the housed medication at designated times, a release button, and a visual indicator.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a medical dispenser having a container in accordance with embodiments of the present invention; and

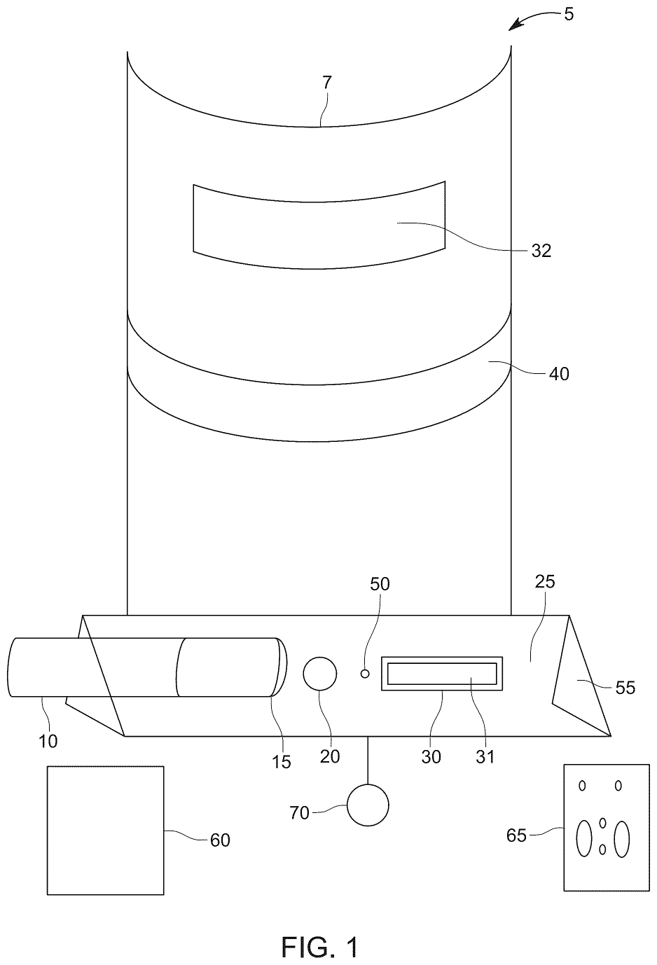

FIG. 2 illustrates another embodiment of a medical dispenser in which the identity sensor is a fingerprint sensor.

### DETAILED DESCRIPTION OF THE PREFERRED EMBODIMENTS

The present invention relates to a medication dispenser device, apparatus, or system, as well as methods of use thereof. In embodiments as shown in the Figures, medication dispenser 5 may be any suitable container suitable for housing and dispensing medication. Medication dispenser 5 may be cylindrical, box-shaped, circular, hexagonal, and the like. Medication dispenser 5 includes housing 7. Housing 7 may be of sufficient size to contain the desired amount of medication. In an embodiment as shown, housing 7 is an interior cavity of medication dispenser 5. Medication dispenser 5 may be composed of any suitable material such as plastic, glass, metal, and the like. The medication may be any suitable medication such as pills, capsules, tablets, gummies, or the like. The medication may of any suitable size and shape. In some embodiments, medication dispenser 5 may be provided to a patient by a healthcare provider. However, medication dispenser 5 may be provided to a patient by any other suitable means. Housing 7 may contain one compartment or multiple compartments with each compartment containing medication.

In embodiments as shown in the Figures, medication dispenser 5 may comprise a dispensing mechanism 10 and/or a locking mechanism 15. Dispensing mechanism 10 may be any suitable means by which to dispense the medication disposed in housing 7 of medication dispenser 5. In embodiments, dispensing mechanism 10 dispenses the medication in particular quantities. For instance, when activated, dispensing mechanism 10 provides an opening from housing 7 sufficient to allow the desired amount of medication to be dispensed. In embodiments, dispensing mechanism 5 dispenses the medication in discrete doses or in specific amounts. Dispensing mechanism 5 may dispense the medication in discrete doses or in specific amounts by any suitable means. In an embodiment, dispensing mechanism 5 is only open for a specific amount of time allowing the specified amount of medicine to be dispensed. In other embodiments, dispensing mechanism 5 when activated opens and then closes allowing only a specified dosage to be dispensed when open.

Locking mechanism 15 provides a means by which to restrict access to and/or restrict the dispensing of the housed medication at particular times. Locking mechanism 15 may be any suitable means to provide such restricted access and/or restrict dispensing of the housed medication. In an embodiment, locking mechanism 15 is a magnet-capable lock. In some embodiments, locking mechanism 15 is a timed lock. In an embodiment, locking mechanism 15 is a remote activated lock.

In embodiments, dispensing mechanism 10 and/or locking mechanism 15 may be programmable. In embodiments, dispensing mechanism 10 and/or locking mechanism 15 may be programmed with coded instructions. In some embodiments, dispensing mechanism 10 and/or locking mechanism 15 may be programmed with preset instructions. Such instructions may include dosing amounts such as the amount of medication to be dispensed from medication dispenser 5. Such instructions may also include dosing amounts such as when to dispense medication from medication dispenser 5 or how much medication to dispense at a certain time. In embodiments, locking mechanism 15 may be programmed to only provide access to and/or allow for the dispensing of the housed medication at certain times and in certain quantities, for instance as designated by the healthcare provider. It is to be understood that the healthcare provider may be a doctor, physician, physician assistant, nurse practitioner, pharmacist, or the like.

In embodiments as shown in the Figures, medication dispenser 5 may comprise release button 20. Release button 20 is disposed on an external surface 25 of medication dispenser 5. Without limitation, release button 20 is for use by the prescribed patient. Release button 20 may be any suitable programmable button having any suitable configuration for use with medication dispenser 5. Release button 20 may be programmed to unlock locking mechanism 15 and activate the dispensing mechanism 10 when activated (i.e., pressed), thereby providing access to and/or allowing for the dispensing of the housed medication. However, the ability of release button 20 to unlock locking mechanism 15 and/or activate dispensing mechanism 10 may depend on the state of medication dispenser 5. In embodiments, medication dispenser 5 may be in an accessible state or in a non-accessible state. For instance, the healthcare provider's administration instructions may designate medication dispenser 5 to be in a state that is accessible or non-accessible depending on certain circumstances. In the accessible state, release button 20, when pressed by an operator (e.g., the prescribed patient), may be capable of unlocking locking mechanism 15 and activating dispensing mechanism 10, thereby administering the housed medication at the instructed times and in the instructed quantities. Alternatively, in the non-accessible state, release button 20, when pressed by the operator, may be incapable of unlocking locking mechanism 15 and activating dispensing mechanism 10, thereby prohibiting access to the housed medication outside of the instructed times and in restricted quantities. In embodiments, the accessible and non-accessible states are programmed into release button 20.

In further embodiments as shown in the Figures, medication dispenser 5 may comprise visual indicator 30 disposed on external surface 25 to visually indicate the times in which the operator may be allowed, or alternatively, not allowed to access the housed medication. Visual indicator 30 may be any visual signal device suitable for providing a visual notice to a user. For instance, visual indicator 30 may provide lights (i.e., colors), text, or any combinations thereof. For instance, visual indicator 30 may show a red color at a time when the operator is not allowed to access the housed medication. Or, visual indicator 30 may show a text that reads “not allowed”. Any suitable text providing source may be used for visual indicator 30. Also, any suitable color providing source may be used for visual indicator 30. In an embodiment, visual indicator 30 may be a multi-colored LED that emits different colored lights depending on the accessibility state of medication dispenser 5. For instance, the multi-colored LED may emit a green light at times when medication dispenser 5 may be in the accessible state, or alternatively the multi-colored LED may emit a red light at times when the medication dispenser may be in the non-accessible state. In embodiments, the multi-colored LED may emit any colored light to signify any particular state in which medication dispenser 5 may be disposed. In some embodiments, the multi-colored LED may be activated by pressing release button 20, thereby indicating the accessibility state of medication dispenser 5. In an embodiment, when the operator presses release button 20 and medication dispenser 5 is in the non-accessible state, the multi-colored LED may be activated and emit a particular-colored light to indicate the non-accessible state. Alternatively, for example, when the operator presses release button 20 and medication dispenser 5 is in the accessible state, the multi-colored LED may be activated and emit a particular-colored light to indicate the accessible state, while additionally unlocking locking mechanism 15 and activating the dispensing mechanism 10.

In further embodiments as shown in the Figures, visual indicator 30 may comprise a digital display 31. Digital display 31 may be any digital display suitable for indicating the accessibility state of medication dispenser 5. Digital display 31 may comprise a monochrome LCD, an RGB LCD, a character LCD, a graphical LCD, a touch LCD, or the like. Digital display 31 may be capable of indicating the accessibility state of medication dispenser 5 by displaying messages and/or images (i.e., to the operator). In embodiments, digital display 31 may transmit a particular message and/or image at times when medication dispenser 5 may be in the accessible state, or alternatively transmit another message and/or image at times when medication dispenser 5 may be in the non-accessible state. Digital display 31 may transmit any message, image, or combination thereof, to signify any particular state in which medication dispenser 5 may be disposed. In addition, digital display 31 may be capable of displaying, without limitation, the type of medication, administration instructions, battery life, time remaining until medication dispenser 5 may be in an accessible state, amount of medication remaining in medication dispenser 5 at any time, and any important reminders, notifications, or alerts such as when medication dispenser 5 may be in the accessible state, when medication dispenser 5 may be low on medication, when medication dispenser 5 may need to be refilled, and/or when medication dispenser 5 may experience a breach of access. Further, digital display 31 may comprise graphical user interface 32 to provide the operator with the ability to interact with medication dispenser 5. Graphical user interface 32 may comprise any graphical user interface suitable for use with interacting with medication dispenser 5. Without limitation, graphical user interface 32 may include any user interface that allows users to interact with electronic devices. Such operator interactions may comprise, without limitation, manipulating medication dispenser 5 settings, silencing reminders, notifications, or alerts, unlocking locking mechanism 15, activating the dispensing mechanism 10, and/or entering an access code or password. In some embodiments, similarly to the multi-colored LED, digital display 31 may be activated by release button 20.

In additional embodiments as shown in the Figures, medication dispenser 5 may comprise audible indicator 40. Audible indicator 40 may be disposed at any suitable location on medication dispenser 5 for providing an audible notification. In an embodiment as shown in the Figures, audible indicator 40 is disposed on external surface 25. Audible indicator 40 may be any device capable of emitting sound and/or vibrations. In an embodiment, audible indicator 40 is a speaker. In embodiments, audible indicator 40 emits sound to remind, notify, and/or alert the operator of a particular state in which medication dispenser 5 may be, such as, without limitation, when medication dispenser 5 may be in the accessible state, when medication dispenser 5 may be low on medication, when medication dispenser 5 needs to be refilled, and/or when medication dispenser 5 may experience a breach of access. In embodiments, audible indicator 40 may be capable of producing various sounds of which may depend on the reminder, notification, and/or alert that may be communicated to the operator. Further, audible indicator 40 may be paired with and/or be separate from the reminders, notifications, and/or alerts that may be transmitted by visual indicator 30.

In some embodiments as shown in the Figures, medication dispenser 5 may be capable of providing varying levels of access to the housed medication, dependent upon the identity of the operator. In embodiments in which the operator may be the prescribed patient, medication dispenser 5 may provide limited medication access to the prescribed patient by the means previously disclosed. Alternatively, in embodiments in which the operator may be an administrator (i.e., an approved authority for providing and/or administering medication dispenser 5 and its housed medication), medication dispenser 5 may provide full medication access to the administrator, including the ability to fill/refill medication dispenser 5 as well as to set certain accessibility guidelines for medication dispenser 5 based on the healthcare provider's administration instructions. In further embodiments, in which the operator may be an unauthorized user or a person other than the prescribed patient or administrator, medication dispenser 5 may provide zero medication access to such person, thus inhibiting the misuse of the housed medication. In the event of a breach of access, such as the prescribed patient forcibly obtaining full access to the housed medication or alternatively, an unauthorized user forcibly obtaining access to the housed medication, medication dispenser 5 may be capable of recognizing a breach and notifying the administrator. Further, in the event of damage or possible tampering by the prescribed patient or unauthorized user, medication dispenser 5 may be capable of recognizing said damage or possible tampering and subsequently enter a state prohibiting any medication accessibility by locking medication mechanism 15 and/or becoming fully disabled. In embodiments, only the administrator may be capable of altering this inaccessibility state and resetting medication dispenser 5 to its previous accessibility state. The programming of disposing mechanism 10 and locking mechanism 15 may be programmed to provide such notices of breach and tampering.

In such embodiments, medication dispenser 5 may utilize any suitable means to determine the varying levels of access to the housed medication. In some embodiments, operators, particularly prescribed patients and administrators, may be required to enter a unique code or password in order to receive access to the housed medication, each unique code or password capable of granting varying levels of medication access. It is to be understood that such unique code or password unlocks locking mechanism 15. Alternatively, in some embodiments, operators, particularly administrators, may be given access to a magnetic mechanism or a key that may be capable of unlocking the medication dispenser by coming in contact with locking mechanism 15, and thereby allowing full medication access to the administrators. In an embodiment in which locking mechanism 15 is a magnet-capable lock, the magnetic mechanism unlocks locking mechanism 15. In such embodiments, the prescribed patients or otherwise may not be given access to the magnetic mechanism or key, and therefore may not be capable of obtaining full access to the housed medication.

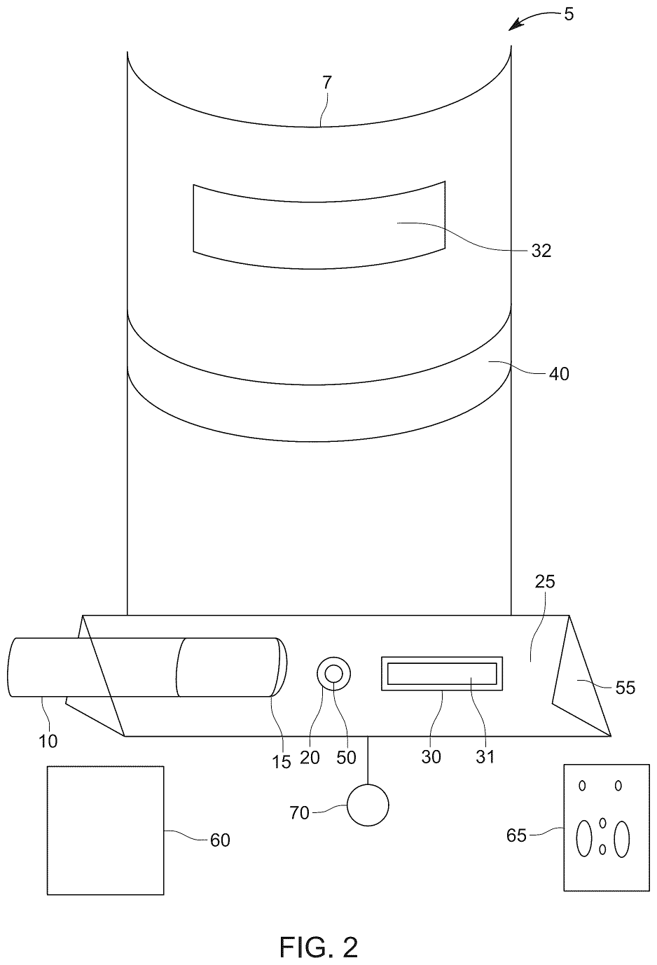

In other embodiments as shown in the Figures, medication dispenser 5 may comprise an identity sensor 50 disposed on external surface 25. Identity sensor 50 may identify the operator, whether that be the prescribed patient, administrator, or otherwise, and thereby determine the appropriate level of medication access. In such embodiments, identity sensor 50 may be a fingerprint scanner, a facial recognition sensor, a camera, or any other identity sensors known to one of ordinary skill in the art. In some embodiments as shown in FIG. 2 in which identity sensor 50 may be a fingerprint scanner, the fingerprint scanner may be incorporated into and/or onto release button 20.

In embodiments shown in the Figures, medication dispenser 5 may comprise a wireless communication system 55 capable of performing the transmission of data or information to and from medication dispenser 5. The data or information transmitted may comprise, without limitation, medication compliance information (i.e., if/when the prescribed patient may be accessing the housed medication), any particular state in which medication dispenser 5 may be, type of medication, administration instructions, battery life, time remaining until medication dispenser 5 may be in an accessible state, amount of medication remaining in medication dispenser 5 at any time, and any important reminders, notifications, or alerts such as when medication dispenser 5 may be in the accessible state, when medical dispenser 5 may be low on medication, when medical dispenser 5 may need to be refilled, and/or when medical dispenser 5 may experience a breach of access. Further, the data or information may be transmitted to a third-party device 60 such as, without limitation, a mobile device or desktop computer equipped with any suitable software or application designed and programmed to allow interfacing with medication dispenser 5. In embodiments, medication dispenser 5 may comprise any suitable wireless communication system known to one of ordinary skill in the art such as, without limitation, mobile broadband, Wi-Fi, and/or Bluetooth. In some embodiments, medication dispenser 5 may additionally be capable of wired communication to perform the transmission of data and information.

In embodiments as shown in the Figures, medication dispenser 5 may comprise a microcontroller 65. Microcontroller 65 may be capable of controlling functionality of the various components of medication dispenser 5, and further may be programmable to allow the controlled functionality to be set by the administrator so as to adhere to the healthcare provider's administration instructions. In embodiments, microcontroller 65 may be any suitable microcontroller known to one of ordinary skill in the art.

In embodiments as shown in the Figures, medication dispenser 5 may comprise power source 70. Power source 70 may be a battery, rechargeable or otherwise, that may be disposed within medication dispenser 5 to power its various components. In embodiments, power source 70 may be any suitable power source known to one of ordinary skill in the art.

Although the present invention and its advantages have been described in detail, it should be understood that various changes, substitutions and alterations may be made herein without departing from the spirit and scope of the invention as defined by the appended claims.

What is claimed is:

1. A medication dispenser for a medication, comprising:
a housing, wherein the medication is disposed within the housing;
a dispensing mechanism, wherein the dispensing mechanism dispenses the medication in designated quantities;
a locking mechanism;
a release button; and
a visual indicator.

2. The medication dispenser of claim 1, wherein the locking mechanism is a magnet-capable lock.

3. The medication dispenser of claim 1, wherein the locking mechanism is a timed lock.

4. The medication dispenser of claim 1, wherein the locking mechanism is a remote activated lock.

5. The medication dispenser of claim 1, wherein the locking mechanism and the dispensing mechanism are programmable.

6. The medication dispenser of claim 5, wherein the locking mechanism and the dispensing mechanism are programmed with coded instructions.

7. The medication dispenser of claim 6, wherein the locking mechanism and the dispensing mechanism are programmed with preset instructions.

8. The medication dispenser of claim 7, wherein the preset instructions comprise when to dispense the medication.

9. The medication dispenser of claim 7, wherein the preset instructions comprise how much medication to dispense at a certain time.

10. The medication dispenser of claim 1, wherein the release button is programmed to unlock the locking mechanism and activate the dispensing mechanism.

11. The medication dispenser of claim 1, wherein the dispensing mechanism comprises an accessible state, wherein the accessible state comprises the release button when pressed to unlock the locking mechanism and activate the dispensing mechanism, thereby dispensing the medication.

12. The medication dispenser of claim 1, wherein the dispensing mechanism comprises a non-accessible state, wherein the non-accessible state comprises the release button when pressed to not unlock the locking mechanism.

13. The medication dispenser of claim 12, wherein the non-accessible state comprises prohibiting access to the medication outside of prescribed times.

14. The medication dispenser of claim 12, wherein the non-accessible state comprises prohibiting access to the medication in restricted quantities.

15. The medication dispenser of claim 1, wherein the visual indicator provides a visual notice to a user.

16. The medication dispenser of claim 1, wherein the visual indicator comprises a multi-colored LED.

17. The medication dispenser of claim 1, wherein the visual indicator comprises a digital display.

18. The medication dispenser of claim 1, wherein the visual indicator comprises a graphical user interface.

19. The medication dispenser of claim 1, wherein the medication dispenser comprises an audible indicator.

20. The medication dispenser of claim 1, wherein the medication sensor comprises an identity sensor.
